(19) United States
(12) Patent Application Publication
(10) Pub. No.: US 2023/0308577 A1
(43) Pub. Date: Sep. 28, 2023

(54) IMAGE READING DEVICE AND IMAGE FORMING APPARATUS

(71) Applicant: FUJIFILM Business Innovation Corp., Tokyo (JP)

(72) Inventor: Takuya ISHIKAWA, Kanagawa (JP)

(73) Assignee: FUJIFILM Business Innovation Corp., Tokyo (JP)

(21) Appl. No.: 17/880,667

(22) Filed: Aug. 4, 2022

(30) Foreign Application Priority Data
Mar. 25, 2022 (JP) 2022-050473

(51) Int. Cl. H04N 1/04; H04N 1/047; H04N 1/10

(52) U.S. Cl. CPC H04N 1/047; H04N 1/0461; H04N 1/1039; H04N 2201/0446; H04N 2201/04755

(57) ABSTRACT

An image reading device includes a placement portion in which a placement surface on which an original document is placed is formed, an imaging portion that is arranged above the placement surface and images the original document, a support portion of which a base end portion is attached to an apparatus main body and that supports the imaging portion in a part on a tip end side, an adjustment portion for adjusting a position of the imaging portion with respect to the placement surface, and a covering portion that covers the adjustment portion.

### CROSS-REFERENCE TO RELATED APPLICATIONS

This application is based on and claims priority under 35 USC 119 from Japanese Patent Application No. 2022-050473 filed Mar. 25, 2022.

### BACKGROUND

### (I) Technical Field

The present invention relates to an image reading device and an image forming apparatus.

### (II) Related Art

A document camera disclosed in JP2004-104341A includes an original document holding section, an imaging section that images an original document held by the original document holding section, a reflection section provided on optical paths of the original document holding section and the imaging section, and a movable holding section that engages with the original document holding section in a pivotable manner via a rotation shaft and holds the imaging section and the reflection section in a pivotable manner via different rotation shafts, in which electric connection between the movable holding section and the original document holding section and electric connection between the movable holding section and the imaging section are made by an electric signal line passing through a center of each rotation shaft.

### SUMMARY

An image reading device is configured to include an imaging portion that images an original document, and a placement portion in which a placement surface on which the original document is placed is formed. In such a configuration, a position of the imaging portion with respect to the placement surface needs to be adjusted. After the adjustment of the position of the imaging portion is completed, accidental changing of the position of the imaging portion by a user has to be suppressed.

However, in a case where a mechanism for adjusting the position of the imaging portion is exposed to an outside, the user may accidentally change the position of the imaging portion.

Aspects of non-limiting embodiments of the present disclosure relate to an image reading device and an image forming apparatus that suppress accidental changing of a position of an imaging portion by a user, compared to a case where a mechanism for adjusting the position of the imaging portion is exposed to an outside.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image reading device including a placement portion in which a placement surface on which an original document is placed is formed, an imaging portion that is arranged above the placement surface and images the original document, a support portion of which a base end portion is attached to an apparatus main body and that supports the imaging portion in a part on a tip end side, an adjustment portion for adjusting a position of the imaging portion with respect to the placement surface, and a covering portion that covers the adjustment portion.

### BRIEF DESCRIPTION OF THE DRAWINGS

Exemplary embodiment(s) of the present invention will be described in detail based on the following figures, wherein:

FIG. 1 is a schematic configuration diagram illustrating an image forming apparatus according to an exemplary embodiment of the present disclosure;

FIG. 2 is a schematic configuration diagram illustrating a toner image forming portion of the image forming apparatus according to the exemplary embodiment of the present disclosure;

FIG. 3 is a perspective view illustrating an image reading device according to the exemplary embodiment of the present disclosure;

FIG. 4 is a perspective view generally illustrating a support portion of the image reading device according to the exemplary embodiment of the present disclosure;

FIG. 5 is a side view illustrating an imaging portion, an adjustment portion, and the like of the image reading device according to the exemplary embodiment of the present disclosure;

FIG. 6 is a front view illustrating the image reading device according to the exemplary embodiment of the present disclosure;

FIG. 7 is a side view illustrating the image reading device according to the exemplary embodiment of the present disclosure;

FIG. 8 is a rear view illustrating the adjustment portion of the image reading device according to the exemplary embodiment of the present disclosure;

FIG. 9 is a rear view illustrating the adjustment portion and the support portion of the image reading device according to the exemplary embodiment of the present disclosure; and

FIG. 10 is a side view illustrating the imaging portion, the adjustment portion, a cover, and the like of the image reading device according to the exemplary embodiment of the present disclosure.

### DETAILED DESCRIPTION

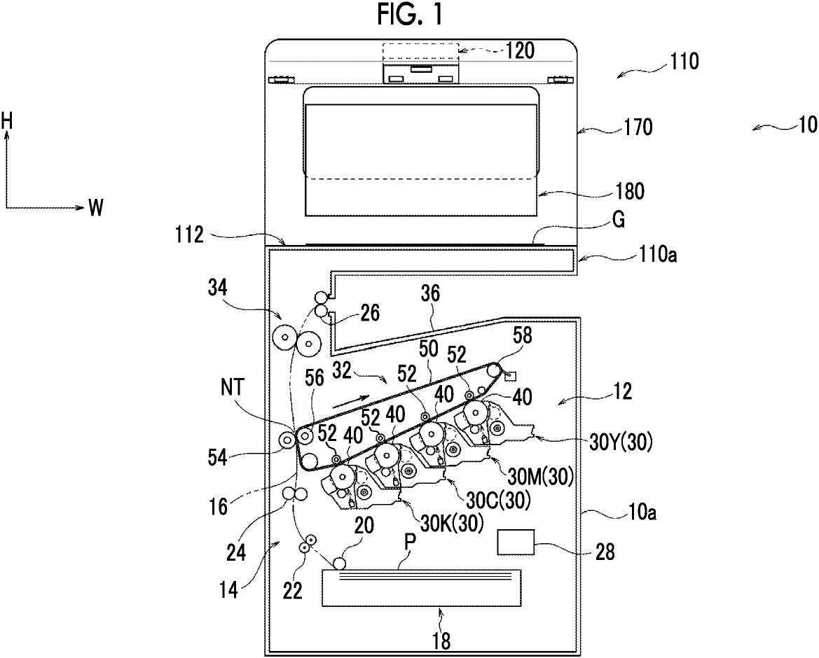

An example of an image forming apparatus according to the exemplary embodiment of the present disclosure will be described in accordance with FIG. 1 to FIG. 10. Arrow H illustrated in each drawing is a vertical direction and denotes an apparatus upward and downward direction. Arrow W is a horizontal direction and denotes an apparatus width direction. Arrow D is a horizontal direction and denotes an apparatus depth direction.

### Overall Configuration of Image Forming Apparatus 10

As illustrated in FIG. 1, an image forming apparatus 10 includes an image reading portion 110 that reads an image formed on an original document G, an image forming portion 12 that forms a toner image using an electrophotographic method, and a transport portion 14 that transports a sheet member P as a recording medium along a transport path 16. In addition, the image forming apparatus 10 includes an accommodation member 18 that accommodates the sheet member P, and a control portion 28 that controls the entire apparatus.

In the image forming apparatus 10 having the above configuration, the image formed on the original document G is read by the image reading portion 110. In addition, the sheet member P accommodated in the accommodation member 18 is transported along the transport path 16 by the transport portion 14. Furthermore, the toner image formed by the image forming portion 12 is formed on the transported sheet member P, and the sheet member P on which the toner image is formed is discharged to an outside of an apparatus main body 10a.

### Image Forming Portion 12

As illustrated in FIG. 1, the image forming portion 12 includes a plurality of toner image forming portions 30 each of which forms a toner image of each color, and a transfer portion 32 that transfers the toner image formed by the toner image forming portions 30 to the sheet member P. Furthermore, the image forming portion 12 includes a fixing device 34 that fixes the toner image transferred on the sheet member P by the transfer portion 32 to the sheet member P.

### Toner Image Forming Portion 30

The plurality of toner image forming portions 30 are provided to form the toner image for each color. In the present exemplary embodiment, toner image forming portions 30Y, 30M, 30C, and 30K of total four colors of yellow (Y), magenta (M), cyan (C), and black (K) are provided. In the following description, Y, M, C, and K attached to the reference numerals will be omitted unless otherwise necessary to distinguish between yellow (Y), magenta (M), cyan (C), and black (K).

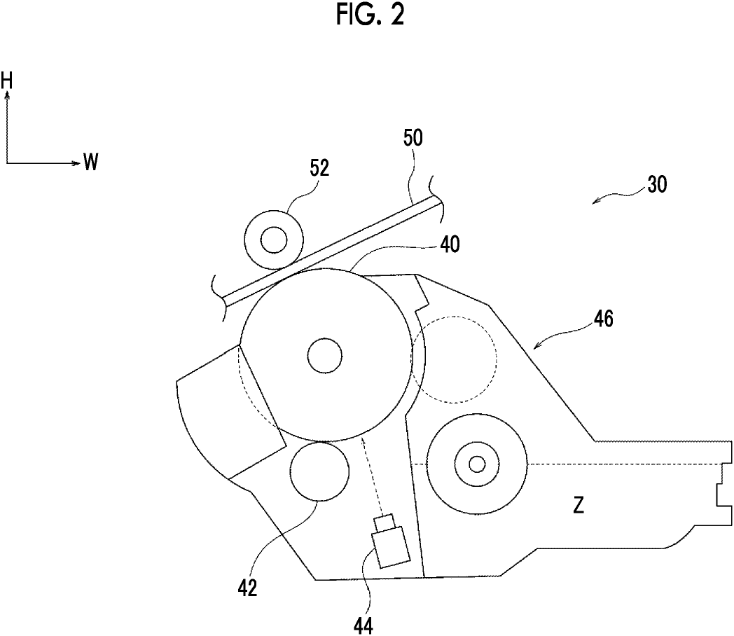

The toner image forming portion 30 of each color is basically configured in the same manner except for a used toner and, as illustrated in FIG. 2, includes an image carrier 40 of a cylindrical shape that rotates, and an electrostatic charger 42 that electrostatically charges the image carrier 40. Furthermore, the toner image forming portion 30 includes an exposure device 44 that forms an electrostatic latent image by irradiating the electrostatically charged image carrier 40 with exposure light, and a developing device 46 that develops the electrostatic latent image as the toner image using a developing agent Z including a toner. Accordingly, the toner image forming portion 30 of each color forms an image of each color using a toner of each color.

In addition, as illustrated in FIG. 1, the image carrier 40 of each color is in contact with a transfer belt 50 (details will be described later) that circulates. The toner image forming portions 30 of yellow (Y), magenta (M), cyan (C), and black (K) are arranged in this order from an upstream side of a circulation direction (refer to the arrow in FIG. 1) of the transfer belt 50.

### Transfer Portion 32

As illustrated in FIG. 1, the transfer portion 32 includes the transfer belt 50, and primary transfer rolls 52 each of which is arranged on an opposite side to the image carrier 40 of each color with the transfer belt 50 interposed between the primary transfer roll 52 and the image carrier 40 and transfers the toner image formed by the image carrier 40 of each color to the transfer belt 50.

In addition, the transfer portion 32 includes a winding roll 56 on which the transfer belt 50 is wound, and a drive roll 58 on which the transfer belt 50 is wound and a rotational force is transmitted to the transfer belt 50. Accordingly, the transfer belt 50 circulates in a direction of the arrow in FIG. 1.

Furthermore, the transfer portion 32 includes a secondary transfer roll 54 that is arranged on an opposite side to the winding roll 56 with the transfer belt 50 interposed between the secondary transfer roll 54 and the winding roll 56 and transfers the toner image transferred on the transfer belt 50 to the sheet member P. A transfer nip NT at which the toner image is transferred to the sheet member P is formed between the secondary transfer roll 54 and the transfer belt 50.

In this configuration, the toner image is primarily transferred to the transfer belt 50 by the primary transfer rolls 52 in order of yellow (Y), magenta (M), cyan (C), and black (K) . In addition, the toner image is transferred by the secondary transfer roll 54 from the transfer belt 50 to the sheet member P transported while being interposed between the transfer belt 50 and the secondary transfer roll 54. Furthermore, the sheet member P on which the toner image is transferred is transported toward the fixing device 34.

### Fixing Device 34

As illustrated in FIG. 1, the fixing device 34 is arranged on a downstream side of the transfer nip NT in a transport direction of the sheet member P. The fixing device 34 fixes the toner image transferred on the sheet member P to the sheet member P by heating and pressurizing the toner image.

### Transport Portion 14

As illustrated in FIG. 1, the transport portion 14 includes a feed roll 20 that feeds the sheet member P accommodated in the accommodation member 18 to the transport path 16, and a prevention roll 22 that prevents multiple feeding of the sheet member P fed by the feed roll 20. Furthermore, the transport portion 14 includes an adjustment roll 24 that adjusts a timing of the sheet member P to be fed to the transfer nip NT, and a discharge roll 26 that discharges the sheet member P on which the toner image is fixed by the fixing device 34 to the outside of the apparatus main body 10a.

### Image Reading Portion 110

As illustrated in FIG. 1, the image reading portion 110 is arranged in an upper part of the image forming apparatus 10 and reads the image formed on the original document G. The image reading portion 110 is an example of an image reading device. Details of the image reading portion 110 will be described later.

### General Configuration

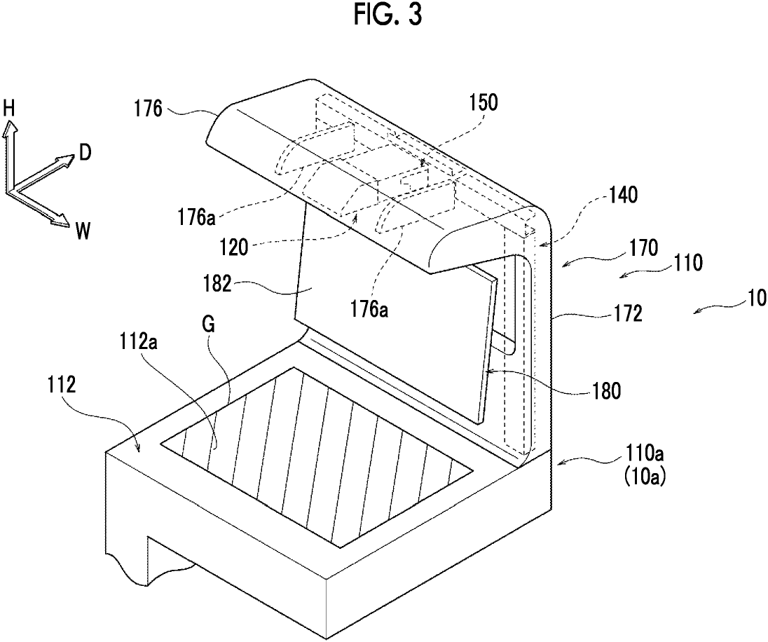

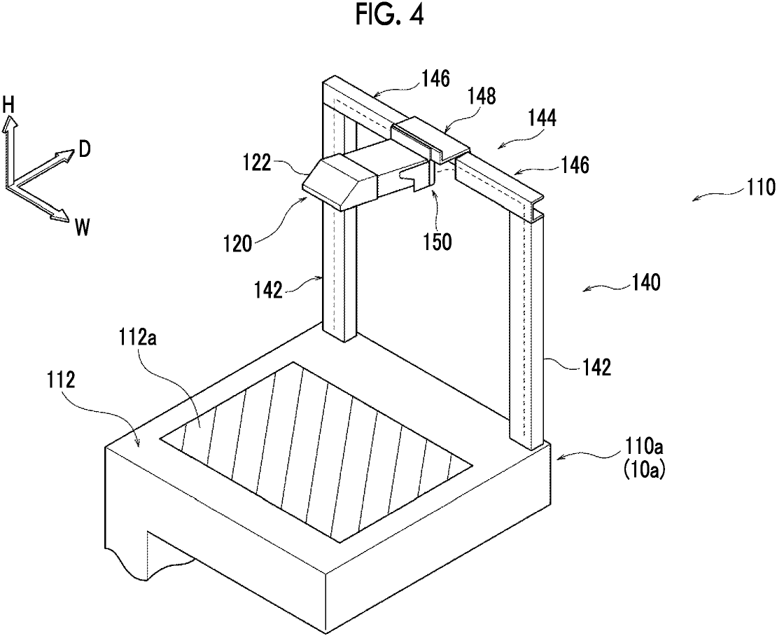

Next, the image reading portion 110 will be described. As illustrated in FIG. 3, the image reading portion 110 includes a top plate 112 in which a placement surface 112a on which the original document G is placed is formed, and an imaging portion 120 that images the original document G placed on the placement surface 112a. Furthermore, as illustrated in FIG. 4, the image reading portion 110 includes a support portion 140 that supports the imaging portion 120, and an adjustment portion 150 for adjusting a position of the imaging portion 120. In addition, as illustrated in FIG. 3, the image reading portion 110 includes a cover 170 that covers the imaging portion 120 and the support portion 140, and a display portion 180 having a display screen 182 on which information related to reading is displayed.

### Top Plate 112

As illustrated in FIG. 3, the top plate 112 is provided in an apparatus main body 110a of the image reading portion 110 and has a plate surface facing upward. The top plate 112 is an example of a placement portion. In the present exemplary embodiment, the apparatus main body 110a is an upper end part of the apparatus main body 10a of the image forming apparatus 10.

In addition, the placement surface 112a on which the original document G of a sheet shape is placed is formed in the top plate 112 (hatched part in FIG. 3). In the present exemplary embodiment, as an example, the original document G of maximum A3 size is placed on the placement surface 112a.

### Support Portion 140

As illustrated in FIG. 4, the support portion 140 includes a pair of vertical frames 142 that are both side parts of the apparatus main body 110a in the apparatus width direction standing upward from a far side part of the apparatus main body 110a in the apparatus depth direction. Furthermore, the support portion 140 includes a horizontal frame 144 that extends across upper end portions of the pair of vertical frames 142.

Here, the apparatus depth direction is a direction of approaching to and separating from the user who stands in front of the image reading portion 110 in order to use the image reading portion 110. A near side of the apparatus depth direction is a side of approaching to the user. A far side of the apparatus depth direction is a side of separating from the user.

In addition, the apparatus width direction is a leftward and rightward direction of the user who stands in front of the image reading portion 110 in order to use the image reading portion 110.

### Vertical Frame 142

The pair of vertical frames 142 have the same configuration and are formed using a metal material. As illustrated in FIG. 4, the vertical frame 142 extends in an upward and downward direction and has a tubular shape of a rectangular cross section. In addition, a base end portion of the vertical frame 142 is attached to the apparatus main body 110a.

### Horizontal Frame 144

The horizontal frame 144 is formed using a metal material and extends in the apparatus width direction as illustrated in FIG. 4. In addition, the horizontal frame 144 is configured to include a pair of tubular frames 146 and a bracket 148.

The pair of tubular frames 146 are symmetric in the apparatus width direction about a center of the placement surface 112a in the apparatus width direction. A base end portion of each tubular frame 146 is connected to a tip end portion of one vertical frame 142, and a tip end portion of one tubular frame 146 extends toward a tip end portion of the other vertical frame 142. In addition, the tubular frame 146 has a tubular shape of a rectangular cross section, and a hollow portion of the tubular frame 146 is connected to a hollow portion of the vertical frame 142.

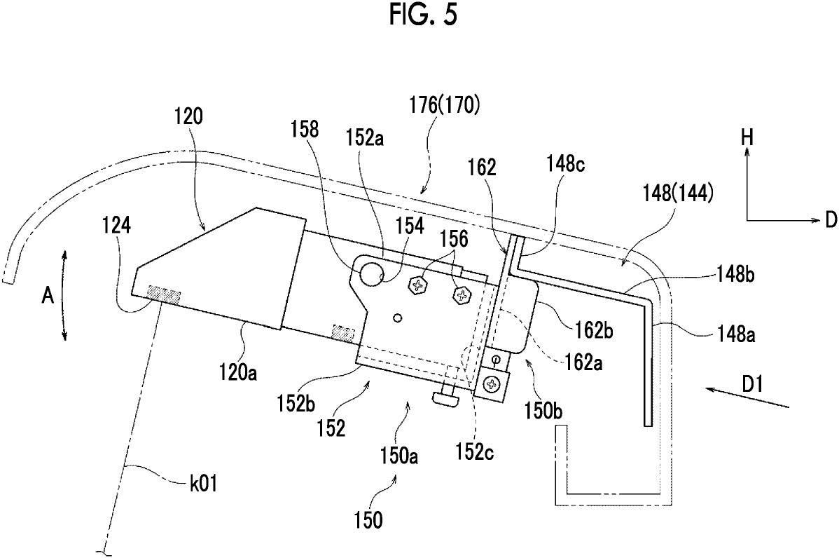

The bracket 148 extends between the tip end portion of one tubular frame 146 and the tip end portion of the other tubular frame 146. As illustrated in FIG. 5, the bracket 148 is formed in a Z shape by bending a plate member and includes a vertical plate 148a of which a plate thickness direction is the apparatus depth direction, and an inclined plate 148b that extends in an inclined manner from a tip end portion of the vertical plate 148a to the near side of the apparatus depth direction. Furthermore, the bracket 148 includes a flange plate 148c that extends upward from a tip end portion of the inclined plate 148b.

Both end portions of the vertical plate 148a in the apparatus width direction are respectively connected to the tip end portions of the pair of tubular frames 146 (refer to FIG. 4).

### Imaging Portion 120

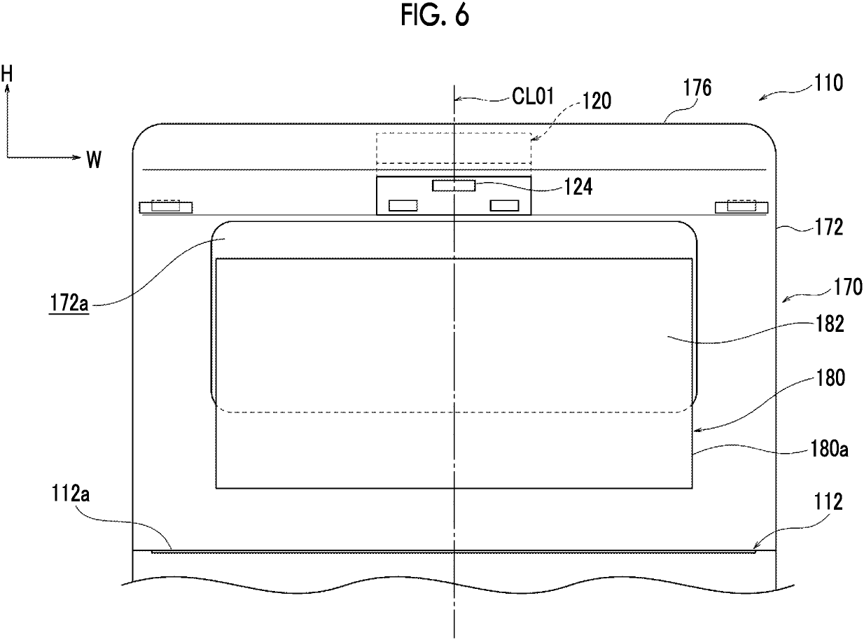

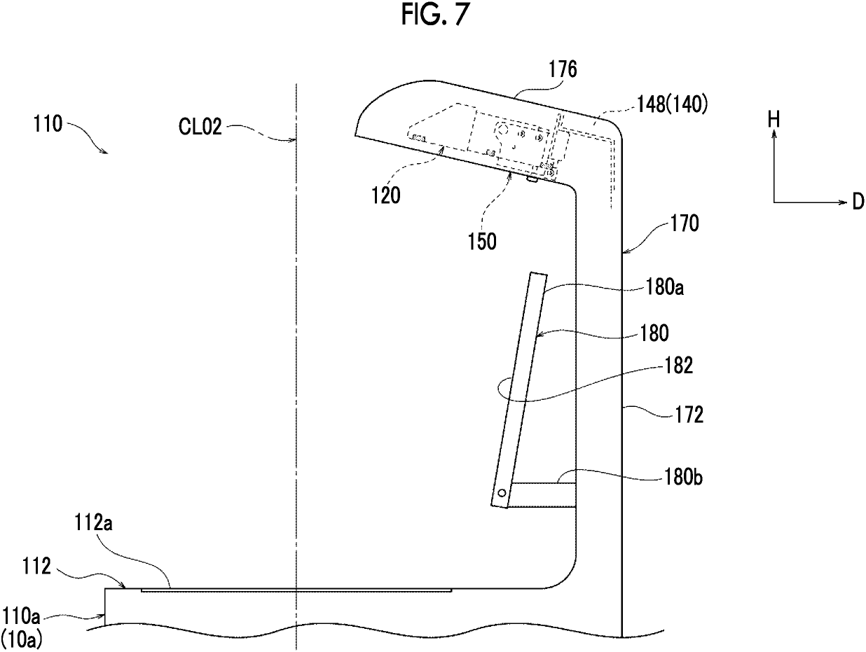

As illustrated in FIG. 6 and FIG. 7, the imaging portion 120 is arranged on a far side with respect to a center (CL01 in FIG. 6) of the placement surface 112a in the apparatus width direction and a center (CL02 in FIG. 7) of the placement surface 112a in the apparatus depth direction.

As illustrated in FIG. 4 and FIG. 5, a housing 122 of the imaging portion 120 has a rectangular solid shape that is inclined with respect to the horizontal direction such that the near side of the apparatus depth direction is positioned above the far side in a view from the apparatus width direction, and of which a part on the near side of the apparatus depth direction is chamfered in a view from the apparatus width direction.

In addition, an imaging optical system is provided inside the housing 122, and a window portion 124 for causing a captured image to enter inside the housing 122 is formed in a part of a lower surface 122a of the housing 122 on the near side of the apparatus depth direction.

Furthermore, while illustration is not provided, a harness connected to the imaging portion 120 extends up to the apparatus main body 110a by passing through the tubular frame 146 and the vertical frame 142.

### Adjustment Portion 150

As illustrated in FIG. 5, the adjustment portion 150 is arranged on a bracket 148 side of the support portion 140 with respect to the imaging portion 120. The adjustment portion 150 includes a bracket 152 attached to the imaging portion 120 and a bracket 162 attached to the flange plate 148c of the bracket 148.

### Bracket 152

The bracket 152 includes a pair of side plates 152a between which a part of the imaging portion 120 on the far side of the apparatus depth direction is interposed in the apparatus width direction, and a bottom plate 152b that is arranged with a gap from the lower surface 120a of the imaging portion 120 and connects lower ends of the pair of side plates 152a. Furthermore, the bracket 152 includes a rear plate 152c that is arranged on the far side of the apparatus depth direction with respect to the imaging portion 120 and of which a plate thickness direction is the apparatus depth direction. The rear plate 152c connects side ends of the pair of side plates 152a.

In addition, a through hole 154 into which a rod 158 that extends in the apparatus width direction and constitutes a shaft portion is inserted is formed in each of the pair of side plates 152a. Furthermore, a through hole, not illustrated, into which a bolt 156 fastened to the imaging portion 120 is inserted is formed in the pair of side plates 152a. The rod 158 is an example of another rotation shaft.

In this configuration, by loosening the bolt 156 and rotating the imaging portion 120 about the rod 158 as a center, the imaging portion 120 rotates in a direction of arrow A, and an optical axis (k01 in FIG. 5) of the imaging optical system of the imaging portion 120 moves in the apparatus depth direction. In other words, by loosening the bolt 156 and rotating the imaging portion 120 about the rod 158 as a center, a position including an attitude of the imaging portion 120 in the apparatus depth direction is adjusted.

An adjustment portion 150a that adjusts the position of the imaging portion 120 in the apparatus depth direction is configured to include the side plate 152a, the bolt 156, and the rod 158. The adjustment portion 150a is an example of another adjustment portion.

### Bracket 162

As illustrated in FIG. 5, the bracket 162 includes a reference plate 162a that overlaps with the rear plate 152c of the bracket 152 from the far side of the apparatus depth direction, and a flange portion 162b that protrudes to the far side of the apparatus depth direction from both ends of the reference plate 162a in the apparatus width direction.

The reference plate 162a is inclined with respect to the upward and downward direction such that an upper end is on the far side of the apparatus depth direction with respect to a lower end in a view from the apparatus width direction. An upper end part of the reference plate 162a does not overlap with the rear plate 152c, and the reference plate 162a is fixed to the flange plate 148c of the bracket 148 in the upper end part using a fixing member not illustrated. The support portion 140 supports the imaging portion 120 via the adjustment portion 150 in a part of the support portion 140 on a tip end side.

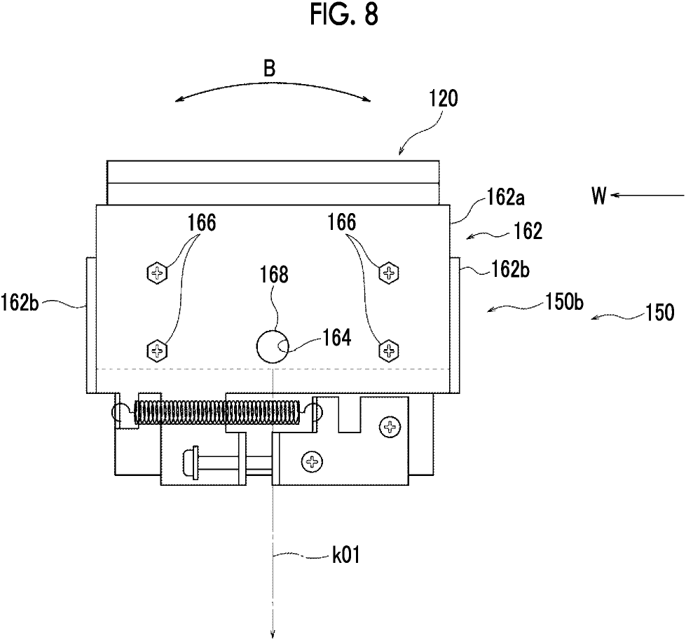

In addition, in a view from a direction (arrow D1 illustrated in FIG. 5) that is orthogonal to a plate surface of the reference plate 162a, a through hole 164 into which a rod 168 that extends in the direction orthogonal to the plate surface of the reference plate 162a is inserted is formed in a center portion of the reference plate 162a in the apparatus width direction as illustrated in FIG. 8. Furthermore, a through hole, not illustrated, through which a bolt 166 fastened to an extruded nut, not illustrated, formed in the rear plate 152c (refer to FIG. 5) is inserted is formed in the reference plate 162a. The rod 168 is an example of a rotation shaft.

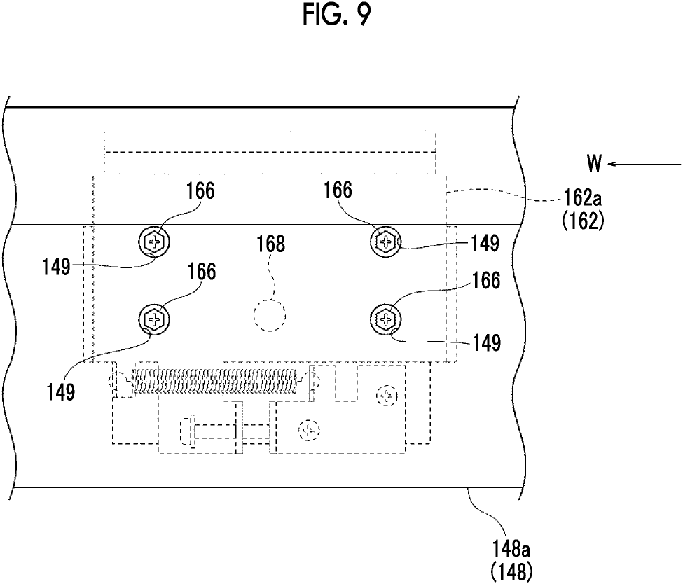

In addition, as illustrated in FIG. 5, the reference plate 162a is covered with the vertical plate 148a of the bracket 148 from the far side of the apparatus depth direction. In a view from the direction orthogonal to the plate surface of the reference plate 162a, an opening 149 through which an adjustment tool (so-called tool for adjustment) passes is formed in the vertical plate 148a as illustrated in FIG. 9 in order to fasten or loosen the bolt 166 using the adjustment tool. The opening 149 is formed on the far side of the apparatus depth direction with respect to the imaging portion 120. In the present exemplary embodiment, for example, a cross head screwdriver is used as the adjustment tool.

In addition, a gap into which the adjustment tool cannot be inserted is formed between the vertical plate 148a and the reference plate 162a.

In this configuration, by loosening the bolt 166 and rotating the bracket 152 and the imaging portion 120 about the rod 168 as a center, the imaging portion 120 rotates in a direction of arrow B as illustrated in FIG. 8, and the optical axis (k01 in FIG. 8) of the imaging optical system of the imaging portion 120 moves in the apparatus width direction. In other words, by loosening the bolt 166 and rotating the imaging portion 120 about the rod 168 as a center, a position including an attitude of the imaging portion 120 in the apparatus width direction is adjusted.

An adjustment portion 150b that adjusts the position of the imaging portion 120 in the apparatus width direction is configured to include the reference plate 162a, the bolt 166, and the rod 168. The adjustment portion 150b is an example of one adjustment portion.

### Cover 170

As illustrated in FIG. 3, the cover 170 covers the imaging portion 120, the adjustment portion 150, and the support portion 140 (refer to FIG. 4). The cover 170 is an example of a covering portion.

The cover 170 is formed using a resin material and has an L shape in a view from the apparatus width direction as illustrated in FIG. 7. Specifically, the cover 170 includes a standing portion 172 that stands upward from the far side part of the apparatus main body 110a in the apparatus depth direction, and an eaves portion 176 that extends to the near side of the apparatus depth direction from an upper end portion of the standing portion 172.

### Standing Portion 172

As illustrated in FIG. 3, the standing portion 172 covers the support portion 140 from the near side and the far side of the apparatus depth direction. In addition, as illustrated in FIG. 6, an opening portion 172a that passes through the standing portion 172 in the apparatus depth direction is formed in the standing portion 172 in a view from the apparatus depth direction. Specifically, the opening portion 172a has a rectangular shape that extends in the apparatus width direction in a view from the apparatus depth direction.

### Eaves Portion 176

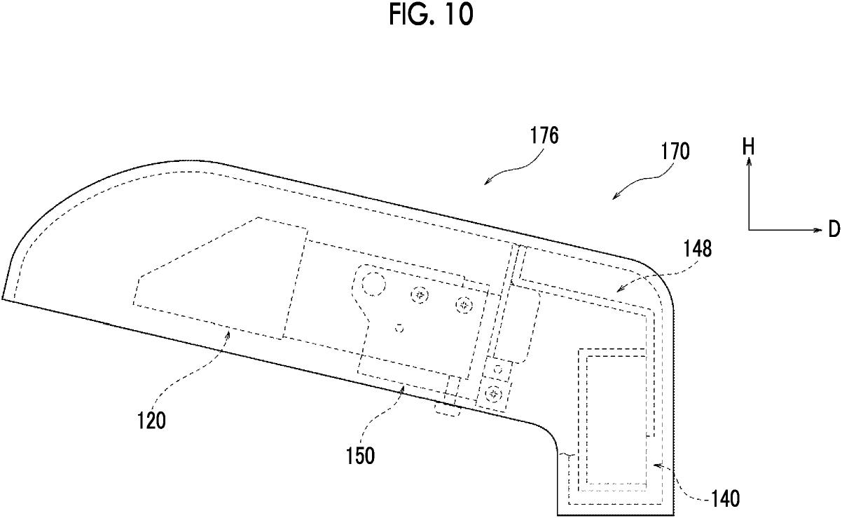

As illustrated in FIG. 10, the eaves portion 176 covers the imaging portion 120, the adjustment portion 150, and the support portion 140 from an upper side of the apparatus upward and downward direction, the near side of the apparatus depth direction, and the far side of the apparatus depth direction. In addition, as illustrated in FIG. 3, a pair of ribs 176a of a plate shape are formed inside a designed surface in the eaves portion 176 such that the pair of ribs 176a are arranged with the imaging portion 120 between the pair of ribs 176a in the apparatus width direction. Specifically, a plate thickness direction of the rib 176a is the apparatus width direction, and the rib 176a covers the adjustment portion 150 from the apparatus width direction.

### Display Portion 180

As illustrated in FIG. 7, the display portion 180 is arranged between the placement surface 112a and the imaging portion 120 in the apparatus upward and downward direction on the far side of the apparatus depth direction with respect to the placement surface 112a.

As illustrated in FIG. 6 and FIG. 7, the display portion 180 includes a main body portion 180a of a plate shape and a support portion 180b that rotatably supports the main body portion 180a. The main body portion 180a has a rectangular plate shape extending in the apparatus width direction and is arranged such that a plate surface faces above the near side of the apparatus depth direction in an inclined manner. The display screen 182 on which information related to reading is displayed using a liquid crystal is provided in the main body portion 180a.

In this configuration, in a case where the user places the original document G on the placement surface 112a and provides an instruction to read the original document G from the display screen 182, the original document G is imaged by the imaging portion 120. Accordingly, the image reading portion 110 reads the original document G.

### Conclusion

As described above, in the image reading portion 110, the eaves portion 176 of the cover 170 covers the adjustment portion 150 from the far side of the apparatus depth direction. Furthermore, the rib 176a of the cover 170 covers the adjustment portion 150 from the apparatus width direction. Accordingly, accidental changing of the position of the imaging portion 120 by the user is suppressed, compared to a case where a mechanism for adjusting the position of the imaging portion is exposed to the outside.

In addition, in the image reading portion 110, the opening 149 through which the adjustment tool passes is formed in the vertical plate 148a of the horizontal frame 144 in order to fasten or loosen the bolt 166 using the adjustment tool. Accordingly, in a state where the cover 170 is detached, the position of the imaging portion 120 supported by the support portion 140 is adjusted using the adjustment tool.

In addition, in the image reading portion 110, the opening 149 is formed on the far side of the apparatus depth direction with respect to the imaging portion 120. Accordingly, accidental changing of the position of the imaging portion 120 by the user is suppressed, compared to a case where the position of the imaging portion can be adjusted from the near side of the apparatus depth direction.

In addition, in the image reading portion 110, the position of the imaging portion 120 in the apparatus depth direction is adjusted by the adjustment portion 150a, and the position of the imaging portion 120 in the apparatus width direction is adjusted by the adjustment portion 150b. The adjustment portion 150a and the adjustment portion 150b are provided on a support portion 140 side with respect to the imaging portion 120. Accordingly, a size of the adjustment portion 150 is reduced, compared to a case where one adjustment portion is arranged on an opposite side to the other adjustment portion with the imaging portion interposed between the adjustment portions.

In addition, in the image reading portion 110, the adjustment portion 150a includes the rod 158 for rotating the imaging portion 120 with respect to the support portion 140, and the adjustment portion 150b includes the rod 168 for rotating the imaging portion 120 with respect to the support portion 140. Accordingly, the size of the adjustment portion 150 is reduced, compared to a case of adjusting the position of the imaging portion by translating the imaging portion.

In addition, in the image forming apparatus 10, the cover 170 covers the adjustment portion 150 that adjusts the position of the imaging portion 120. Accordingly, deviation of a position at which an image is formed from a normal position is suppressed, compared to a case where the image reading portion in which the adjustment portion that adjusts the position of the imaging portion is exposed to the outside is provided. Here, the normal position is a position at which a center of the image overlaps with a center of the sheet member P.

While the present disclosure is described in detail with respect to a specific exemplary embodiment, the present disclosure is not limited to such an exemplary embodiment. A person skilled in the art will perceive that other various exemplary embodiments can be made to the present disclosure within the scope of the present disclosure. For example, in the exemplary embodiment, while the opening 149 through which the adjustment tool passes is formed in the vertical plate 148a of the horizontal frame 144, the opening may not be formed. However, in this case, an effect achieved by forming the opening 149 is not achieved.

In addition, in the exemplary embodiment, while the adjustment portion 150a and the adjustment portion 150b are provided on the support portion 140 side with respect to the imaging portion 120, for example, any one or both of the adjustment portion 150a and the adjustment portion 150b may be provided on a base end side of the support portion. However, in this case, an effect achieved by providing the adjustment portion 150a and the adjustment portion 150b on the support portion 140 side with respect to the imaging portion 120 is not achieved.

In addition, in the exemplary embodiment, the position of the imaging portion 120 is adjusted in the adjustment portion 150a by rotating the imaging portion 120, and the position of the imaging portion 120 is adjusted in the adjustment portion 150b by rotating the imaging portion 120. Instead, the position of the imaging portion may be adjusted by translating the imaging portion. However, in this case, an effect achieved by adjusting the position of the imaging portion 120 by rotating the imaging portion 120 is not achieved.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image reading device comprising:
a top plate in which a placement surface on which an original document is placed is formed;
an optical imaging system that is arranged above the placement surface and images the original document;
a support frame of which a base end portion is attached to an apparatus main body and that supports the optical imaging system in a part on a tip end side, wherein the support frame includes a pair of vertical frames that are both side parts of the apparatus main body in an apparatus width direction standing upward from a far side part of the apparatus main body in an apparatus depth direction, and a horizontal frame that extends across upper end portions of the pair of vertical frames;
an adjustment bracket for adjusting a position of the optical imaging system with respect to the placement surface in the apparatus width direction and the apparatus depth direction; and
a cover that covers and encompasses the adjustment bracket and the support frame.

2. The image reading device according to claim 1,
wherein the support frame supports the optical imaging system via the adjustment bracket, and
an opening through which an adjustment tool passes is formed in the support frame so that the adjustment by the adjustment bracket is performed using the adjustment tool.

3. The image reading device according to claim 2,
wherein the opening is formed on a far side of an apparatus depth direction with respect to the optical imaging system.

4. The image reading device according to claim 1,
wherein the adjustment bracket includes one adjustment bracket for adjusting the position of the optical imaging system in the apparatus width direction with respect to the placement surface and another adjustment bracket for adjusting the position of the optical imaging in the apparatus depth direction with respect to the placement surface, and the one adjustment bracket and the other adjustment bracket are provided on a support frame side with respect to the imaging optical imaging system.

5. The image reading device according to claim 2,
wherein the adjustment bracket includes one adjustment bracket for adjusting the position of the imaging optical imaging system in the apparatus width direction with respect to the placement surface and another adjustment bracket for adjusting the position of the imaging optical imaging system in the apparatus depth direction with respect to the placement surface, and the one adjustment bracket and the other adjustment bracket are provided on a support frame side with respect to the optical imaging system.

6. The image reading device according to claim 3,
wherein the adjustment bracket includes one adjustment bracket for adjusting the position of the imaging optical imaging system in the apparatus width direction with respect to the placement surface and another adjustment bracket for adjusting the position of the optical imaging system in the apparatus depth direction with respect to the placement surface, and the one adjustment bracket and the other adjustment bracket are provided on a support frame side with respect to the optical imaging system.

7. The image reading device according to claim 4,
wherein the one adjustment bracket includes a rotation shaft for rotating the imaging optical imaging system with respect to the support frame, and
the other adjustment bracket includes another rotation shaft for rotating the optical imaging system with respect to the support frame.

8. The image reading device according to claim 5,
wherein the one adjustment bracket includes a rotation shaft for rotating the optical imaging system with respect to the support frame, and
the other adjustment bracket includes another rotation shaft for rotating the optical imaging system with respect to the support frame.

9. The image reading device according to claim 6,
wherein the one adjustment bracket includes a rotation shaft for rotating the optical imaging system with respect to the support frame, and
the other adjustment bracket includes another rotation shaft for rotating the optical imaging system with respect to the support frame.

10. An image forming apparatus comprising:
the image reading device according to claim 1; and
an image forming device that forms an image based on image information read by the image reading device, the image forming device being disposed under the image reading device.

11. An image forming apparatus comprising:
the image reading device according to claim 2; and
an image forming device that forms an image based on image information read by the image reading device, the image forming device being disposed under the image reading device.

12. An image forming apparatus comprising:
the image reading device according to claim 3; and
an image forming device that forms an image based on image information read by the image reading device, the image forming device being disposed under the image reading device.

13. An image forming apparatus comprising:
the image reading device according to claim 4; and
an image forming device that forms an image based on image information read by the image reading device, the image forming device being disposed under the image reading device.

14. An image forming apparatus comprising:
the image reading device according to claim 5; and
an image forming device that forms an image based on image information read by the image reading device, the image forming device being disposed under the image reading device.

15. An image forming apparatus comprising:
the image reading device according to claim 6; and
an image forming device that forms an image based on image information read by the image reading device, the image forming device being disposed under the image reading device.

16. An image forming apparatus comprising:
the image reading device according to claim 7; and
an image forming device that forms an image based on image information read by the image reading device, the image forming device being disposed under the image reading device.

17. An image forming apparatus comprising:
the image reading device according to claim 8; and
an image forming device that forms an image based on image information read by the image reading device, the image forming device being disposed under the image reading device.

18. An image forming apparatus comprising:
the image reading device according to claim 9; and
an image forming device that forms an image based on image information read by the image reading device, the image forming device being disposed under the image reading device.
